(19) United States
(12) Patent Application Publication
(10) Pub. No.: US 2024/0354562 A1
(43) Pub. Date: Oct. 24, 2024

(54) POLYNOMIAL APPROXIMATION OF DEEP LEARNING MODELS

(71) Applicant: International Business Machines Corporation, Armonk, NY (US)

(72) Inventors: Itamar Zimerman, Tel-Aviv (IL); Jenny Lerner, Haifa (IL); Moran Baruch, Petah Tikva (IL); Nir Drucker, Zichron Yaakov (IL)

(73) Assignee: International Business Machines Corporation, Armonk, NY (US)

(21) Appl. No.: 18/137,175

(22) Filed: Apr. 20, 2023

(51) Int. Cl. G06N 3/08

(52) U.S. Cl. CPC G06N 3/08

(57) ABSTRACT

An embodiment includes performing a dedicated training process on a non-polynomial neural network resulting in a trained polynomial neural network, where the training process includes performing a plurality of training iterations on the neural network, and performing, between the training iterations, loss processing that (i) minimizes a loss of the neural network and (ii) reduces a range of values to a non-polynomial layer (NPL) of the neural network. The embodiment estimates a range of input values to the NPL of the thus trained neural network. The embodiment forms a replacement layer for the NPL, where the replacement layer comprises a polynomial approximation of an operation performed by the NPL. The embodiment also generates a revised neural network by replacing the NPL of the trained neural network with the replacement layer.

### BACKGROUND

The present invention relates generally to data processing using deep learning models. More particularly, the present invention relates to a method, system, and computer program for polynomial approximation of deep learning models.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)—also referred to simply as a neural network—is a type of computational model that can recognize patterns in data and make predictions or decisions based on that information, using interconnected nodes that process and transmit information

A Deep Learning Neural Network, referred to herein as a Deep Neural Network (DNN) is an ANN with multiple hidden layers of units between the input and output layers. Similar to shallow ANNs—which are neural networks with a very small number of layers, e.g., a single hidden layer, DNNs can model complex non-linear relationships. DNN architectures, e.g., for object detection and parsing, generate compositional models where the object is expressed as a layered composition of image primitives. The extra layers enable composition of features from lower layers, giving the potential of modeling complex data with fewer units than a similarly performing shallow network. DNNs are typically designed as feedforward networks.

### SUMMARY

The illustrative embodiments provide for polynomial approximation of deep learning models. An embodiment includes performing a training process on a neural network resulting in a trained neural network, where the training process performs a plurality of training iterations on the neural network, and performs, between the training iterations, loss processing that (i) minimizes a loss of the neural network and (ii) reduces the range of the input value to a non-polynomial layer (NPL) of the neural network. The embodiment also includes estimating a range of the input values to the NPL of the thus trained neural network. The embodiment also includes determining a replacement layer for the NPL, where the replacement layer comprises a polynomial approximation of an operation performed by the NPL. The embodiment also includes using statistical analysis to approximate the real input ranges of the NPL. The embodiment also includes generating a revised neural network by replacing the NPL of the trained neural network with the replacement layer. Other embodiment allows to efficiently adapt the polynomial degree to the actual ranges of the NPL inputs. Other embodiments of this aspect include corresponding computer systems, apparatus, and computer programs recorded on one or more computer storage devices, each configured to perform the actions of the embodiment.

In embodiment, the performing of the training process on the neural network advantageously further includes training the neural network using a first training dataset, where the estimating of the range of input values to the NPL includes inputting instances of a second training dataset to the trained neural network and determining corresponding training input values to the NPL. Thus, the embodiment provides an alternate method of training the neural network.

In another embodiment, the estimating of the range of input values to the NPL advantageously further includes performing a statistical analysis using the training input range to the NPL. Thus, the embodiment provides an alternate estimation method.

Another embodiment advantageously further determines the polynomial approximation of the operation performed by the NPL, where the determining of the polynomial approximation includes determining a degree of the polynomial approximation based at least in part on the estimated range of input values to the NPL. Thus, the embodiment provides an alternate approximation method.

In another embodiment, the NPL is advantageously selected from the group consisting an activation layer, an instance normalization layer, a maximum pooling layer, and a softmax layer. Thus, the embodiment provides a modified method of NPL selection.

In another embodiment, the polynomial approximation is advantageously a polynomial approximation of the activation function. Thus, the embodiment provides an alternate approximation approach.

In another embodiment, the neural network includes several NPLs including the NPL, and where the performing of the loss processing includes minimizing NPL input values to each of the plurality of an NPLs. Thus, the embodiment provides an alternate approach to loss processing.

In another embodiment, the performing of the loss processing includes minimizing NPL input values to each of the plurality of an NPLs during respective separate training iterations. Thus, the embodiment provides an alternate approach to loss processing.

In another embodiment, the performing of the loss processing includes minimizing the loss of the neural network using a loss function that includes a standard loss term and a regularization range loss term. Thus, the embodiment provides an alternate approach to loss processing.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example service infrastructure in accordance with an illustrative embodiment;

FIG. 3 depicts a block diagram of an example processing environment for generating and deploying an HE-compatible neural network in accordance with an illustrative embodiment;

FIG. 4 depicts a block diagram of an exemplary model approximation module in accordance with an illustrative embodiment;

FIG. 5 depicts a block diagram of an exemplary training module and loss module in accordance with an illustrative embodiment;

FIG. 6 depicts a block diagram of an exemplary range estimation module in accordance with an illustrative embodiment;

FIG. 7 depicts a block diagram of an exemplary replacement layer module in accordance with an illustrative embodiment; and

FIG. 8 depicts a flowchart of an example process for polynomial approximation of deep learning models in accordance with an illustrative embodiment.

### DETAILED DESCRIPTION

Predictive modeling refers to a form of predictive analytics that typically uses a machine learning (ML) algorithm to build a predictive model (also referred to herein as a ML model or ML predictive model), such as a neural network. A neural network as referred to herein may be any type of neural network, including any of the different types of neural networks discussed above. There are countless applications for such models; however, for the sake of clarity of explanation, examples of applications are described herein that are only provided as illustrative context and are in no way intended to limit the scope of the present disclosure. There are also various performance metrics for predictive models (e.g., precision, specificity, error type, F1 score, etc.); however, for the sake of simplicity, predictive model performance will simply be referred to herein as model accuracy. The quality of a predictive model is typically based on the model's accuracy, with more accurate models generally being more desirable (subject to reasonable constraints, such as processing costs, etc.).

Achieving state-of-the-art levels of accuracy often comes with considerable processing expense. Many current machine-learning algorithms require more processing power than is typically available on a general-purpose computer system. For this reason, a typical machine-learning implementation involves the use of cloud-based systems that are designed to handle the types of heavy workloads involved with machine learning processing.

However, for applications involving private or personal data, protecting such sensitive data is crucial when using third-party cloud environments, particularly for complying with regulations such as GDPR (EU General Data Protection Regulation, 2016) and HIPAA (Centers for Medicare & Medicaid Services, 1996). As a result, many industries seek solutions that provide data privacy and confidentiality.

One potential solution is the use of Homomorphic Encryption (HE), which enables certain types of computations (addition and multiplication) on encrypted data. The HE system has an encryption operation Enc: R₁→R₂ that encrypts input plaintext from the ring R₁ (+, *) into ciphertexts in the ring R₂ (⊕, ⊙) and an associated decryption operation Dec: R₂→R₁. An HE scheme is correct if for every valid input x; y∈R₁

$$D e c ( E n c ( x ) ) = x \qquad ( 1 )$$

$$Dec ( E n c ( x ) ⊕ E n c ( y ) ) = x + y \qquad ( 2 )$$

$$Dec ( En c ( x ) ⊙ En c ( y ) ) = x * y \qquad ( 3 )$$

and is approximately correct if for some small ε>0 that is determined by the key, it follows that |x−Dec(Enc(x))|≤ε. Equations 2, and 3 are modified in the same way.

Thus, for a cloud-based application that is limited to such computations, sensitive data could remain encrypted the entire time it resides on the cloud server. Despite the potential the HE technology presents, there are obstacles to the widespread adoption of HE solutions due in part to the limitations on the types of computations that can be performed with practical latency and accuracy.

A proposed solution is to use well-known Remez algorithms to derive an optimal minimax polynomial approximation p(x) of a fixed degree that minimizes the maximum absolute difference between the polynomial p(x) and the function f(x) of the neural network layer being approximated. Two parameters affect the accuracy of the approximation—the range [a, b] of inputs and the polynomial degree. Higher degrees or smaller ranges result in a more accurate approximation. However, a higher degree polynomial might harm the efficiency of the evaluation as larger polynomials require more computations and often increase the overall noise. On the other hand, for a traditional neural network, there is no way to predict whether the inputs to a layer will remain within a small enough range to prevent errors.

For example, activation function layers are crucial components of neural networks. In the absence of the activation function layers, neural networks collapse into linear models. The problem is that the activation function layers involve computations that are not compatible with HE data, and because the activation layers are so important in a neural network, an accurate HE-friendly approximation of the neural network cannot be created without the activation layers. Therefore, the activation layers must remain or be replaced with polynomial approximations thereof; but as discussed above, this has traditionally meant that the resulting approximation will either face the problems associated with high-degree polynomials or face the problems associated with large input ranges.

For activation layers, the problem of unpredictable and oversized input ranges is particularly pronounced. The main issue is that the input range for the polynomial approximations of activation layers increases per layer, and thus the deviation of the approximations from the original activation layers gradually increases. In practice, when dealing with large neural networks with multiple approximated activation layers, the error from the initial approximation layers is accumulated and eventually causes the neural network to “explode”, i.e., the weights become too high for the neural network to converge. This dilemma has presented a significant problem and a roadblock to the implementation of HE technology that would allow for end-to-end neural network processing of encrypted sensitive data.

The present disclosure addresses these and other challenges by introducing “HE-friendly” neural networks in which layers that require computations that are not practically possible on HE data have been replaced with “HE-friendly” layers. According to some embodiments, a neural network revision process replaces each non-HE-friendly layer of a neural network with an HE-friendly layer that includes a polynomial approximation of the layer being replaced.

In an exemplary embodiment, the process trains the original neural network, where the original neural network still includes the NPLs (the non-HE-friendly layers). While specific types of layers are used as examples of NPLs in the descriptions of the embodiments presented herein, the present disclosure is equally applicable to other types of NPLs. Examples of NPLs include activation layers, instance normalization layers, maximum pooling layers, and softmax layers.

The process performs multiple training iterations on the neural network. A training iteration may be an epoch or may involve use of only a subset of training data instances.

At training, the process applies a regularization loss to each NPL input. This loss reduces the NPL input range so the polynomial will be easier to approximate. As a result, the input ranges are squeezed during the training process, making the approximation process much easier. Besides the regularization range loss (also referred to as RRL), the process also uses standard loss (for instance cross entropy or mean squared error), which the process uses to adjust model weights to maintain the network's performance. Note that the whole training procedure can be applied to a non-polynomial model before training or after initial training.

In some embodiments, RRL the loss function includes an RRL term that is added to a standard loss term. The RRL term encourages the model weights of the neural network to produce smaller values for the NPL input values. Non-limiting examples of the RRL term include expressions (1) through (5) below:

$${\sum }_{i = 1}^{L} {‖ {x}_{i} ‖}_{1} \qquad ( 1 )$$

$${\sum }_{i = 1}^{L} \frac{{‖ {x}_{i} ‖}_{1}}{{c}_{i}} \qquad ( 2 )$$

$${\sum }_{i = 1}^{L} \frac{{‖ {x}_{i} ‖}_{∞}}{{c}_{i}} \qquad ( 3 )$$

$${\sum }_{i = 1}^{L} \frac{{p}_{i} {‖ {x}_{i} ‖}_{∞}}{{c}_{i}} \qquad ( 4 )$$

Where ∥x∥ₚ is the Lₚ-norm of the vector x, L is the number of NPLs, xᵢ represents the input of the i^{th} NPL, and cᵢ represents the number of neurons in layer i. In expression (4), p₁>p₂>p₃> . . . >p_{L} to avoid the possibility of snowball effects. In expression (5), we often set p=∞ and q∈{1, 2, . . . , ∞}.

In some embodiments, the process estimates a range of the input values to the NPLs of the trained neural network. In some embodiments, the process samples the inputs to the NPLs using a separate set of training data from the training dataset used previously to train the neural network. The process then uses the sampled input values to estimate the range of input values to each of the NPLs. The process estimates these ranges by performing a statistical analysis.

In an exemplary embodiment, the process then determines replacement layers for each of the NPLs. The process determines the operation being performed by the NPL being replaced. The process then determines a polynomial approximation of the operation, as well as the estimated range of inputs. In some embodiments, the process uses the estimated range of inputs to determine a degree of the polynomial approximation. In some embodiments, the NPL may be an activation layer, and the operation performed by the NPL is based on an activation function, in which case the polynomial approximation is a polynomial approximation of the activation function. Alternatively, the NPL may include any other type of operation that is not compatible with HE.

In an exemplary embodiment, the process generates a revised neural network by replacing the NPLs of the trained neural network with the replacement layers. The revised neural network may then be deployed in a production environment. The revised neural network includes only layers that are HE compatible, and therefor allows the data being processed by the revised neural network to remain encrypted as it progresses through the entirety of the revised neural network.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

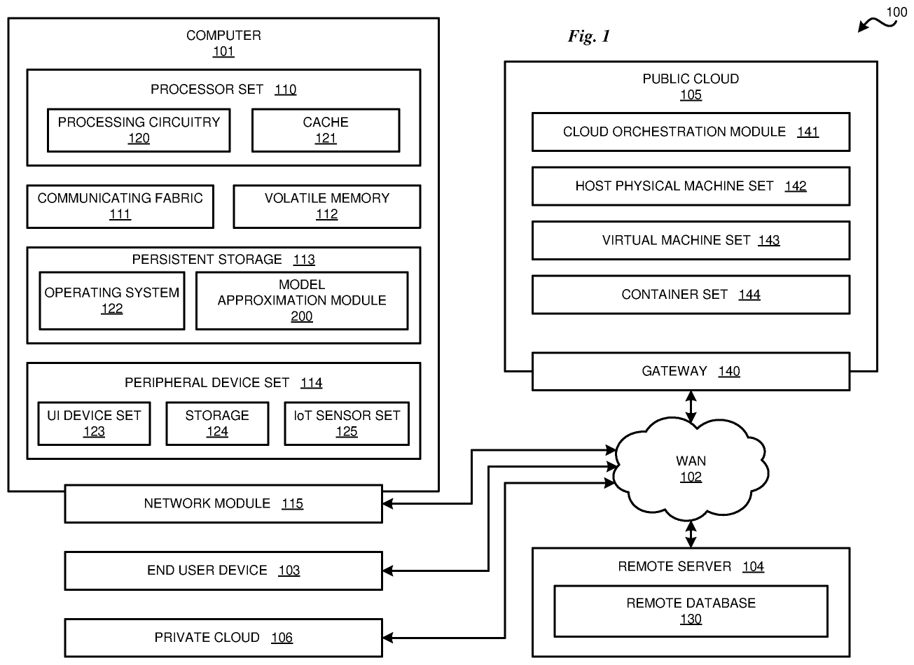

With reference to FIG. 1, this figure depicts a block diagram of a computing environment 100. Computing environment 100 contains an example of an environment for the execution of at least some of the computer code involved in performing the inventive methods, such as an improved model approximation module 200 that provides polynomial approximation of deep learning models. In addition to model approximation module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and model approximation module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in model approximation module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in model approximation module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

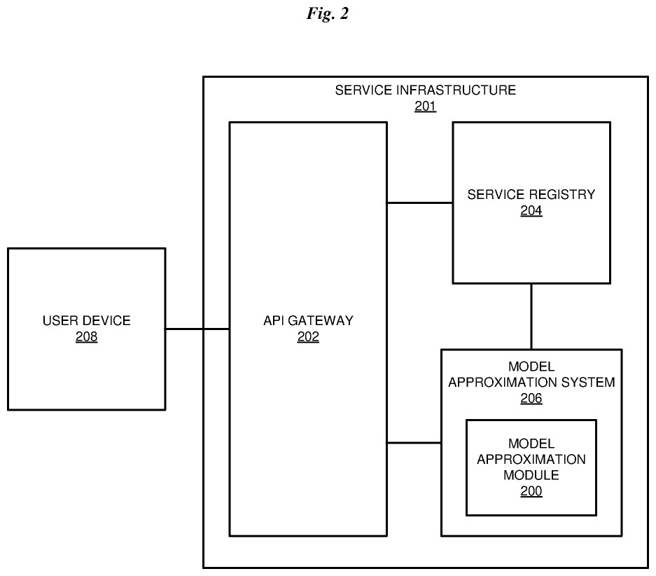

With reference to FIG. 2, this figure depicts a block diagram of an example service infrastructure 201 in accordance with an illustrative embodiment. In the illustrated embodiment, the service infrastructure 201 includes a model approximation system 206. In an embodiment, the model approximation system 206 is an example of the computer 101 of FIG. 1 and includes the model approximation module 200 of FIG. 1.

In the illustrated embodiment, the service infrastructure 201 provides services and service instances to a user device 208. User device 208 communicates with service infrastructure 201 via an API gateway 202. In various embodiments, service infrastructure 201 and its associated model approximation system 206 serve multiple users and multiple tenants. A tenant is a group of users (e.g., a company) who share a common access with specific privileges to the software instance. Service infrastructure 201 ensures that tenant specific data is isolated from other tenants.

In the illustrated embodiment, service infrastructure 201 includes a service registry 204. In some embodiments, the model approximation system 206 is a virtual machine and the service registry 204 looks up service instances of model approximation system 206 in response to a service lookup request such as one from API gateway 202 in response to a service request from user device 208. For example, in some embodiments, the service registry 204 looks up service instances of model approximation system 206 in response to requests related to model approximation from the user device 208.

In some embodiments, service registry 204 maintains information about the status or health of each service instance including performance information associated each of the service instances. In some such embodiments, such information may include various types of performance characteristics of a given service instance (e.g., cache metrics, etc.) and records of updates.

In some embodiments, user device 208 connects with API gateway 202 via any suitable network or combination of networks such as the Internet, etc. and uses any suitable communication protocols such as Wi-Fi, Bluetooth, etc. Service infrastructure 201 may be built on the basis of cloud computing. API gateway 202 provides access to client applications like the model approximation module 200. API gateway 202 receives service requests issued by client applications and creates service lookup requests based on service requests. As a non-limiting example, in an embodiment, the user device 208 executes a routine to initiate interaction with the model approximation module 200. For instance, in some embodiments, the user device 208 executes a routine to initiate revision of a neural network to an HE compatible neural network such as described in connection with the embodiments disclosed herein.

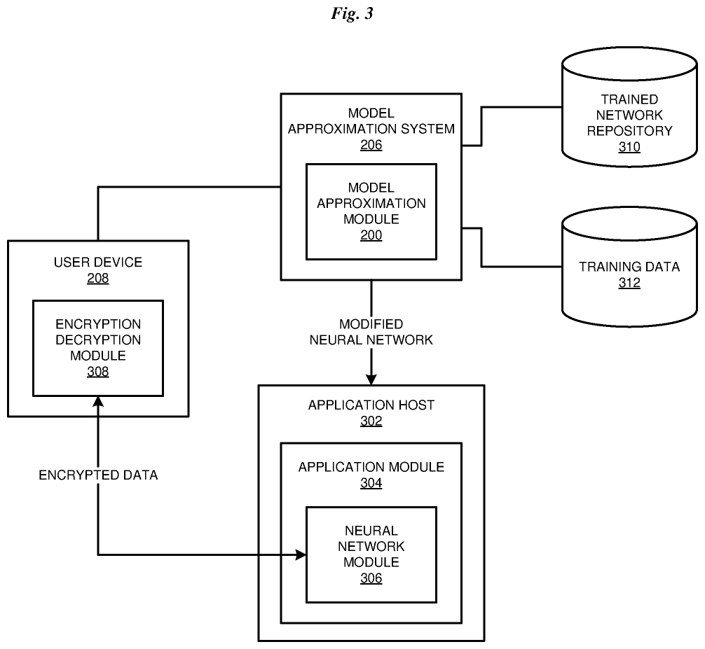

With reference to FIG. 3, this figure depicts a block diagram of an example processing environment for generating and deploying an HE-compatible neural network in accordance with an illustrative embodiment.

In the illustrated embodiment, an end-to-end privacy-preserving machine learning (PPML) solution is provided that allows for running a neural network over HE. The illustrated embodiment comprises a user device 208, a model approximation system 206, and an application host 302. The embodiment allows the user device 208 to issue a command to the model approximation module 200 hosted by the model approximation system 206 such that the command triggers the model approximation module 200 to initiate training an unencrypted HE-friendly neural network model, and then upload the trained HE-friendly model to an application host 302 for use in a neural network module 306 for an application module 304. In some embodiments, the user device 208 may then process private information using the neural network module 306 while the private information is encrypted. For example, the user device 208 includes an encryption/decryption module 308 that encrypts the data prior to sending the data to the neural network module 306, and then decrypts the results received from the neural network module 306.

In some embodiments, the model approximation module 200 starts with a pre-trained neural network stored in a trained network repository 310, wherein the pre-trained neural network is not compatible with processing encrypted data. In some such embodiments, the model approximation module 200 uses training data from the training data 312 to train the pre-trained neural network and modify the pre-trained neural network to be compatible with processing encrypted data. In some embodiments, the model approximation module 200 trains the pre-trained neural network using a regularization term added to the loss function that encourages a reduction of the range of the inputs to layers that are not HE compatible (NPLs). The model approximation module 200 then generates polynomial approximations of the non-HE compatible layers, and replaces the non-HE compatible layers with the polynomial approximation layers, resulting in the modified neural network that is HE-compatible.

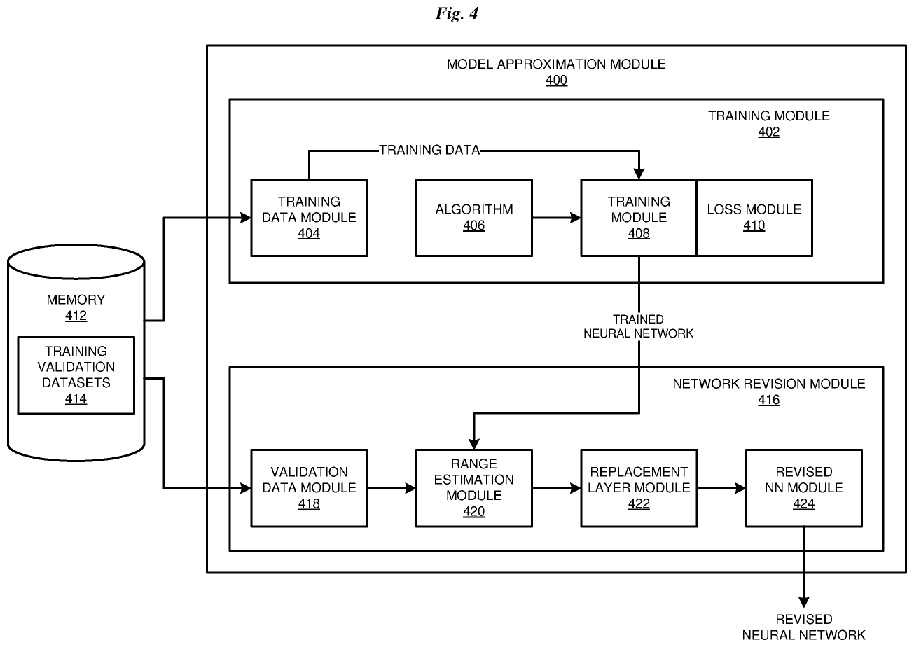

With reference to FIG. 4, this figure depicts a block diagram of an exemplary model approximation module 400 in accordance with an illustrative embodiment. In the illustrated embodiment, the model approximation module 400 is an example of the model approximation module 200 of FIGS. 1-3.

In the illustrated embodiment, the model approximation module 400 comprises a training module 402 and a network revision module 416. The training module 402 comprises a training data module 404, an algorithm 406, a training module 408, and a loss module 410. The network revision module 416 comprises a validation data module 418, a range estimation module 420, a replacement layer module 422, and a revised neural network (NN) module 424. In alternative embodiments, the model approximation module 400 can include some or all of the functionality described herein but grouped differently into one or more modules. In some embodiments, the functionality described herein is distributed among a plurality of systems, which can include combinations of software and/or hardware based systems, for example Application-Specific Integrated Circuits (ASICs), computer programs, or smart phone applications.

In the illustrated embodiment, the training module 402 receives training data from the training/validation datasets 414 stored in memory 412. In some embodiments, the training module 402 is configured to train a neural network using supervised training, meaning the neural network is trained using labeled training data. In some such embodiments, the training dataset comprises a heterogeneous matrix in which each row is an instance, and each column is a feature, except for an extra label column that is included in the training data for supervised learning. Thus, each row is a valuation of the set of features for a given instance, plus a label used during the training process to check the output of the model for accuracy.

The training data module 404 receives the training data from the memory 412 and buffers the training data, providing each instance in turn to the training module 408. The training module 408 receives the training data from the training data module 404 and receives an algorithm 406 and generates a trained neural network for a predictive model. In some embodiments, the training module 408 retrains a pre-trained neural network, in which case the training module 408 receives the pre-trained neural network instead of the algorithm 406. In embodiments in which the training module 408 is generating a new trained neural network, the algorithm 406 may be any of a variety of known algorithms having tunable parameters that are adjusted during the training phase to create a trained neural network model and improve the accuracy of the model's predicted outputs for new inputs.

In the illustrated embodiment, the training module 402 includes a loss module 410 that performs, between training iterations, loss processing that (i) minimizes a loss of the neural network and (ii) encourages a reduction of the range of the input value to an NPL. More specifically, the loss module 410 adjusts model weights of the neural network according to a loss function that selects new weight values that will minimize the loss of the neural network and encourage smaller input values to each of the NPLs.

The training module 408 and loss module 410 continue to perform training iterations until the loss is minimized, at which point the NPLs should expect inputs in the minimal range so that the model preserves its performance. In the illustrated embodiment, the network revision module 416 receives the trained neural network and determines a revised version of the neural network that is fully HE compatible, meaning that the revised neural network only includes operations that can be performed on data that has been HE encrypted.

The range estimation module 420 uses empirical analysis to estimate the input ranges per layer [xⁱₘᵢₙ<xⁱₘₐₓ]_{0≤i<}1 with confidence level α. The range estimation module 420 does this by approximating the ranges of the input to each NPL by sampling a validation dataset that is received and buffered by the validation data module 418 and was not used by the training module 402. In some embodiments, the range estimation module 420 estimates the range of input values to the NPLs by performing a statistical analysis using the training input values to the NPLs.

The replacement layer module 422 replace the original NPLs with layers having HE-compatible polynomial approximations, using e.g., Remez or the faster but less accurate least-square polynomial fit function. For example, in some embodiments, the NPLs are activation layers, and each activation layer is replaced by a separate polynomial that has been designed for the estimated input range.

The revised NN module 424 generates the revised neural network by replacing the NPLs of the trained neural network with the replacement layers determined by the replacement layer module 422. The output of the replacement layer module 422 is an HE-friendly model. However, since the polynomial activation layers provide only an approximation of the original activations, the accuracy of the model is normally decreased. Therefore, in some embodiments, the revised NN module 424 fine-tunes the revised neural network for a few more epochs or iterations of training data with the added range loss term until the desired performance is achieved.

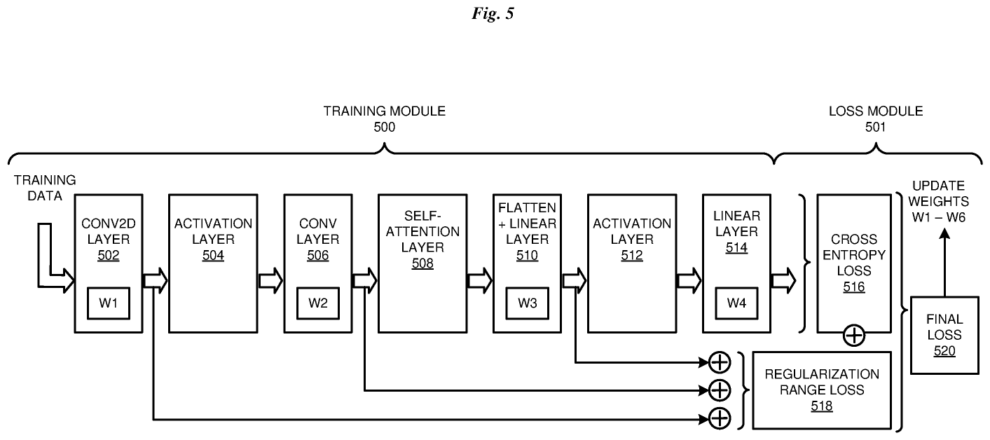

With reference to FIG. 5, this figure depicts a block diagram of an exemplary training module 500 and loss module 501 in accordance with an illustrative embodiment. In the illustrated embodiment, the training module 500 is an example of the training module 408 of FIG. 4, and the loss module 501 is an example of the loss module 410 of FIG. 4.

In the illustrated embodiment, a neural network having layers 502-514 is undergoing training by a training module 500 and a loss module 501. The neural network comprises a conv2d layer 502, an activation layer 504, a conv layer 506, a self-attention layer 508, a flatten+linear layer 510, an activation layer 512, and a linear layer 514. Among these layers, the activation layer 504, the self-attention layer 508, and the activation layer 512 are not HE-compatible layers.

In the illustrated embodiment, the training module 500 trains the original neural network, where the original neural network still includes the NPLs 504, 508, and 512. The training module 500 performs multiple training iterations on the neural network. A training iteration may be an epoch or may involve use of only a subset of training data instances. During the training iteration, the cross-entropy loss 516 collects outputs from the neural network while the RRL 518 collects input values to the NPLs. Between iterations, the final loss 520 is determined and used to adjusts the weights W1-W4 of layers conv2d layer 502, conv layer 506, flatten+linear layer 510, and linear layer 514, respectively. In some embodiments, the final loss 520 determines adjusted weight values for weights W1-W4 according to the results of a loss function used by the final loss 520 that includes an RRL term from the RRL 518 added to a standard loss term from the cross entropy loss 516 that minimizes the error. In alternative embodiment, other loss functions may be used, such as a mean squared error loss function, or an absolute percentage error loss function.

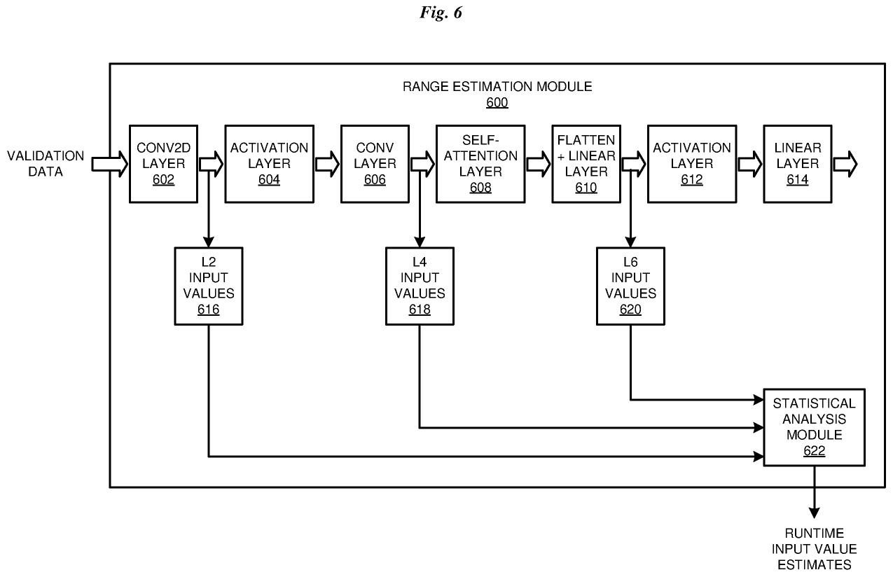

With reference to FIG. 6, this figure depicts a block diagram of an exemplary range estimation module 600 in accordance with an illustrative embodiment. In the illustrated embodiment, the range estimation module 600 is an example of the range estimation module 420 of FIG. 4.

In the illustrated embodiment, a neural network having layers 602-614 is undergoing range estimation processing that will approximate the range of input values that the revised neural network will expect to receive during inference. The neural network comprises a conv2d layer 602, an activation layer 604, a conv layer 606, a self-attention layer 608, a flatten+linear layer 610, an activation layer 612, and a linear layer 614. Among these layers, the activation layer 604, the self-attention layer 608, and the activation layer 612 are not HE-compatible layers.

In the illustrated embodiment, the range estimation module 600 estimates a range of the input values to the NPLs of the thus trained neural network. The range estimation module 600 includes a statistical analysis module 622. The statistical analysis module 622 samples the training inputs to the NPLs using a separate set of training data from the training dataset used previously to train the neural network. In the illustrated embodiment, the statistical analysis module 622 collects L2 (activation layer 604) input values 616, L4 (self-attention layer 608) input values 618, and L6 (activation layer 612) input values 620.

The statistical analysis module 622 uses empirical analysis to estimate the input ranges per layer [xⁱₘᵢₙ<xⁱₘₐₓ]_{0≤i<L with confidence level α. The statistical analysis module 622 does this by approximating the ranges of the inputs to each NPL by performing a statistical analysis using the L}2 input values 616, L4 input values 618, and L6 input values 620.

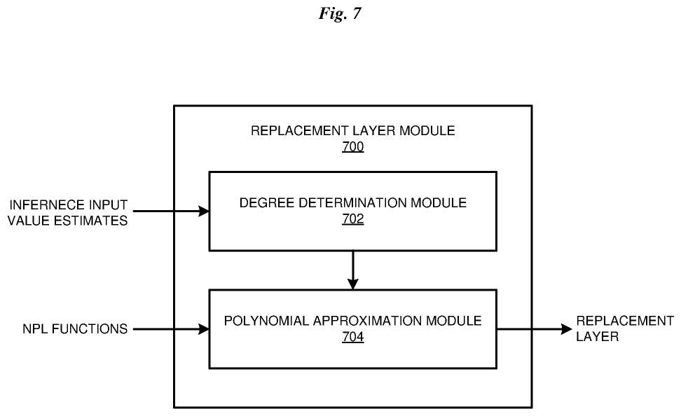

With reference to FIG. 7, this figure depicts a block diagram of an exemplary replacement layer module 700 in accordance with an illustrative embodiment. In the illustrated embodiment, the replacement layer module 700 is an example of the replacement layer module 422 of FIG. 4.

In the illustrated embodiment, the replacement layer module 700 includes a degree determination module 702 and a polynomial approximation module 704. In alternative embodiments, the model approximation module 400 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the replacement layer module 700 determines a replacement layer for each NPL. Each replacement layer comprises a polynomial approximation of an operation performed by the corresponding NPL. The degree determination module 702 receives the input value estimates determined by the range estimation module 600. The degree determination module 702 uses the estimated range of input values for a designated NPL to determine a degree for the polynomial.

The polynomial approximation module 704 receives the NPL function to be approximated for the designated NPL and receives the degree for the designated NPL from the degree determination module 702. The polynomial approximation module 704 then determines the polynomial approximation of the operation performed by the designated NPL by using, e.g., Remez or the faster but less accurate least-square polynomial fit function. For example, in some embodiments, the designated NPL is an activation layer, and the activation layer is replaced by a polynomial that has been designed for the estimated input range.

The replacement layer module 700 repeats this process for each NPL that needs to be replaced. Once the replacement layer module 700 has processed each of the NPLs, the replacement layer module 700 outputs the corresponding replacement layers to the revised NN module 424 to be integrated into a revised neural network.

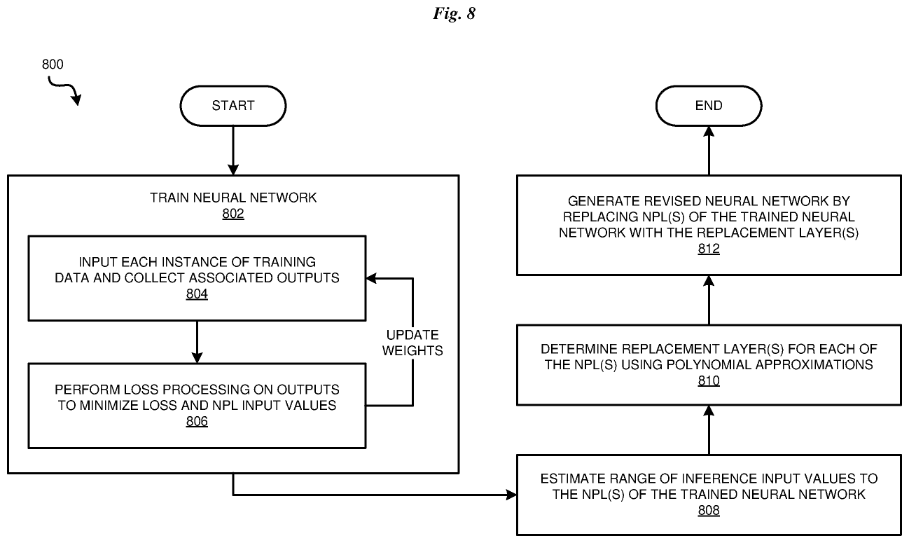

With reference to FIG. 8, this figure depicts a flowchart of an example process 800 for polynomial approximation of deep learning models in accordance with an illustrative embodiment. In a particular embodiment, the model approximation module 200 of FIGS. 1-3 or model approximation module 400 of FIG. 4 carries out the process 800.

In the illustrated embodiment, at block 802, the process trains an original neural network, where the original neural network still includes the NPLs. The process performs multiple training iterations on the neural network. A training iteration may be an epoch or may involve use of only a subset of training data instances.

The training process at block 802 includes multiple iterations of block 804 and block 806. At block 804, the process inputs each instance of training data and collects associated outputs. The process also collects input values to the NPLs.

At block 806, the process performs loss processing on outputs to minimize error and reduce the range of the NPL input values. The process applies a regularization loss to each NPL input. This loss reduces the NPL input range that the polynomial will be easier to approximate. As a result, the input ranges are squeezed during the training process, making the approximation process much easier. Besides the RRL, the process also uses standard loss (for instance cross entropy or mean squared error), which the process uses to adjust model weights to maintain the network's performance. Note that the whole training procedure can be applied to a non-polynomial model before training or after initial training.

In some embodiments, the RRL is determined according to a loss function that includes an RRL term that is added to a standard loss term (for the standard loss). The RRL term accepts the input values collected during the most recent iteration of block 804 as inputs and encourages the model weights of the neural network to produce smaller values for the NPL input values.

Next, at block 808, the process estimates ranges of input values to the NPL(s) of the trained neural network. In some embodiments, the process samples the inputs to the NPLs using a separate set of training data from the training dataset used previously to train the neural network. The process then uses the sampled input values to estimate the range of input values to each of the NPLs. The process estimates these ranges by performing a statistical analysis.

Next, at block 810, the process determines replacement layer(s) for each of the NPL(s) using polynomial approximations. In some embodiments, the process determines an operation being performed by an NPL being replaced. The process then determines a polynomial approximation of the operation based at least in part on the estimated range of inputs. In some embodiments, the process uses the estimated range of inputs to determine a degree of the polynomial approximation. In some embodiments, the NPL may be an activation layer, and the operation performed by the NPL is based on an activation function, in which case the polynomial approximation is a polynomial approximation of the activation function. Alternatively, the NPL may include any other type of operation that is not compatible with HE.

Next, at block 812, the process generates a revised neural network by replacing NPL(s) of the trained neural network with the replacement layer(s). The revised neural network may then be deployed in a production environment. The revised neural network includes only layers that are HE compatible, and therefor allows the data being processed by the revised neural network to remain encrypted as it progresses through the entirety of the revised neural network.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
performing a training process on a neural network resulting in a trained neural network, the training process comprising:
performing a plurality of training iterations on the neural network; and
performing, between the training iterations, loss processing that (i) minimizes a loss of the neural network and (ii) reduces a range of values to a non-polynomial layer (NPL) of the neural network;
estimating a range of input values to the NPL of the trained neural network;
forming a replacement layer for the NPL, wherein the replacement layer comprises a polynomial approximation of an operation performed by the NPL; and
generating a revised neural network by replacing the NPL of the trained neural

2. The computer-implemented method of claim 1, wherein the performing of the training process on the neural network comprises training the neural network using a first training dataset, and wherein the estimating of the range of input values to the NPL comprises inputting instances of a second training dataset to the trained neural network and determining corresponding training input values to the NPL.

3. The computer-implemented method of claim 2, wherein the estimating of the range of input values to the NPL comprises performing a statistical analysis using the training input range to the NPL.

4. The computer-implemented method of claim 3, further comprising:
determining the polynomial approximation of the operation performed by the NPL, wherein the determining of the polynomial approximation comprises determining a degree of the polynomial approximation based at least in part on the estimated range of input values to the NPL.

5. The computer-implemented method of claim 1, wherein the NPL is selected from the group consisting an activation layer, an instance normalization layer, a maximum pooling layer, and a softmax layer.

6. The computer-implemented method of claim 5, wherein the polynomial approximation is a polynomial approximation of the activation function.

7. The computer-implemented method of claim 1, wherein the neural network comprises a plurality of NPLs including said NPL, and wherein the performing of the loss processing comprises minimizing NPL input values to each of the plurality of an NPLs.

8. The computer-implemented method of claim 7, wherein the performing of the loss processing comprises minimizing NPL input values to each of the plurality of an NPLs during respective separate training iterations.

9. The computer-implemented method of claim 1, wherein the performing of the loss processing comprises minimizing the loss of the neural network using a loss function that includes a standard loss term and a regularization range loss term.

10. A computer program product comprising one or more computer readable storage media, and program instructions collectively stored on the one or more computer readable storage media, the program instructions executable by a processor to cause the processor to perform operations comprising:
performing a training process on a neural network resulting in a trained neural network, the training process comprising:
performing a plurality of training iterations on the neural network; and
performing, between the training iterations, loss processing that (i) minimizes a loss of the neural network and (ii) reduces a range of values to a non-polynomial layer (NPL) of the neural network;
estimating a range of input values to the NPL of the trained neural network;
forming a replacement layer for the NPL, wherein the replacement layer comprises a polynomial approximation of an operation performed by the NPL; and
generating a revised neural network by replacing the NPL of the trained neural network with the replacement layer.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

13. The computer program product of claim 10, wherein the performing of the training process on the neural network comprises training the neural network using a first training dataset, and wherein the estimating of the range of input values to the NPL comprises inputting instances of a second training dataset to the trained neural network and determining corresponding training input values to the NPL.

14. The computer program product of claim 13, wherein the estimating of the range of input values to the NPL comprises performing a statistical analysis using the training input range to the NPL.

15. The computer program product of claim 14, the operations further comprising:
determining the polynomial approximation of the operation performed by the NPL, wherein the determining of the polynomial approximation comprises determining a degree of the polynomial approximation based at least in part on the estimated range of input values to the NPL.

16. The computer program product of claim 10, wherein the NPL is selected from the group consisting an activation layer, an instance normalization layer, a maximum pooling layer, and a softmax layer.

17. The computer program product of claim 16, wherein the polynomial approximation is a polynomial approximation of the activation function.

18. A computer system comprising a processor and one or more computer readable storage media, and program instructions collectively stored on the one or more computer readable storage media, the program instructions executable by the processor to cause the processor to perform operations comprising:
performing a training process on a neural network resulting in a trained neural network, the training process comprising:
performing a plurality of training iterations on the neural network; and
performing, between the training iterations, loss processing that (i) minimizes a loss of the neural network and (ii) reduces a range of values to a non-polynomial layer (NPL) of the neural network;
estimating a range of input values to the NPL of the trained neural network;
forming a replacement layer for the NPL, wherein the replacement layer comprises a polynomial approximation of an operation performed by the NPL; and
generating a revised neural network by replacing the NPL of the trained neural network with the replacement layer.

19. The computer system of claim 18, wherein the neural network comprises a first layer and a second layer, wherein the second layer is the NPL, and wherein, for an iteration in the plurality of training iterations:
the neural network generates a weighted output value by applying a first weight value to an output of the first layer, and
the NPL receives the weighted output value as an input value in the range of input values.

20. The computer system of claim 19, wherein the loss processing comprises adjusting the first weight value.

21. A computer-implemented method comprising:
performing, on a neural network comprising at least a first layer and a second layer, wherein the second layer is a non-polynomial layer (NPL), a training process on a neural network resulting in a trained neural network, the training process comprising:
performing a plurality of training iterations on the neural network, wherein in a certain training iteration a weighted output value is generated by using a first weight value to generate an output of the first layer and the weighted output value is sent as an input value in the NPL; and
performing, between a selected training iteration and another training iteration after the selected training iteration, loss processing that (i) minimizes a loss of the neural network and (ii) reduces a range of values to the NPL of the neural network;
estimating a range of input values to the NPL of the trained neural network;
forming a replacement layer for the NPL, wherein the replacement layer comprises a polynomial approximation of an operation performed by the NPL; and
generating a revised neural network by replacing the NPL of the trained neural network with the replacement layer.

22. The computer-implemented method of claim 21, wherein the loss processing comprises adjusting the first weight value.

23. The computer-implemented method of claim 21, wherein the performing of the training process on the neural network comprises training the neural network using a first training dataset, and wherein the estimating of the range of input values to the NPL comprises inputting instances of a second training dataset to the trained neural network and determining corresponding training input values to the NPL.

24. The computer-implemented method of claim 23, wherein the estimating of the range of input values to the NPL comprises performing a statistical analysis using the training input range to the NPL.

25. A computer program product comprising one or more computer readable storage media, and program instructions collectively stored on the one or more computer readable storage media, the program instructions executable by a processor to cause the processor to perform operations comprising:
performing, on a neural network comprising at least a first layer and a second layer, wherein the second layer is a non-polynomial layer (NPL), a training process on a neural network resulting in a trained neural network, the training process comprising:
performing a plurality of training iterations on the neural network, wherein in a certain training iteration a weighted output value is generated by using a first weight value to generate an output of the first layer and the weighted output value is sent as an input value in the NPL; and
performing, between a selected training iteration and another training iteration after the selected training iteration, loss processing that (i) minimizes a loss of the neural network and (ii) reduces a range of values to the NPL of the neural network;
estimating a range of input values to the NPL of the trained neural network;
forming a replacement layer for the NPL, wherein the replacement layer comprises a polynomial approximation of an operation performed by the NPL; and
generating a revised neural network by replacing the NPL of the trained neural network with the replacement layer.
